(19) United States
(12) Patent Application Publication
(10) Pub. No.: US 2003/0020313 A1
(43) Pub. Date: Jan. 30, 2003

(54) Structure for adjusting backrest frame inclined angle of chairs

(76) Inventor: Lausan Chung-Hsin Liu, Hsin-Tien City (TW)

Correspondence Address: BACON & THOMAS, PLLC, 4th Floor, 625 Slaters Lane, Alexandria, VA, 22314-1176, US

(21) Appl. No.: 09/915,304

(22) Filed: Jul. 27, 2001

(51) Int. Cl. B60N 2/02

(52) U.S. Cl. 297/354.12

(57) ABSTRACT

A structure for adjusting backrest frame inclined angle of a chair includes a support frame pivotally engaged with a backrest frame to form the chair and two adjusting seats mounted to two sides of the support frame. The adjusting seats may match inclined angles of the backrest frame. There are two adjusting bars fastening to two sides of the backrest frame and having a displacement rod bridged therebetween. The adjusting bars may be moved to actuate the displacement rod changing displacements in the adjusting seats thereby to adjust the inclined angle of the backrest frame to give an user sitting on the chair most comfort.

### BACKGROUND OF THE INVENTION

The present invention relates to a structure for adjusting backrest frame inclined angle of chairs and particularly a structure allowing users to easily change the backrest frame inclined angle of a chair to have most comfortable sitting.

Many chairs nowadays offer features to adjust the inclined angle of the backrest frame or the elevation of the seat pad to suit users' desires and preferences. The mechanisms for adjusting the backrest frame generally include two adjusting ratchets located at two sides on a lower end of the backrest frame. Each adjusting ratchet is disposed in an inclined manner and has a separating section with a plurality of adjusting slots to match the inclined angles of the backrest frame. The chair has two bars located at two sides pivotally engaged with an adjusting rod which may be wedged into the adjusting slots. The backrest frame is pivotally engaged with a seat pad. When the backrest frame is moved forwards, the adjusting ratchets will be separated from the adjusting rod, then move and turn the adjusting rod upwards or downwards about an axis pivotal to the chair to a position matching a desired inclined angle of the backrest frame, then move the backrest frame rearwards to wedge the adjusting rod into a selected adjusting slot to complete the inclined angle adjustment for the backrest frame.

However the adjusting method set forth above requires users leaving the chair during adjustment processes. Moreover, different chairs have different designs; the adjusting slots and angles are also different. Users who have made adjustments and are accustomed to one type of chair often have to make repetitive adjustments again when sitting on another type of chairs. All this creates annoying problems to users.

### SUMMARY OF THE INVENTION

The primary object of the invention is to resolve the foregoing disadvantages. The invention aims to provide a structure that allows users to adjust the backrest frame inclined angle of a chair during sitting. The structure of the invention has an adjusting seat located on a support frame which is pivotally engaged with a backrest frame to form a chair. Two adjusting bars are provided at two sides of the chair with a displacement rod bridged therebetween. The adjusting bars may be moved to change the displacement of the displacement rod in the adjusting seat thereby to change the inclined angle of the backrest frame to give users most sitting comfort

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is a fragmentary perspective view of the invention.

FIGS. 3A and 3B are schematic views of the invention in movement.

FIG. 4 is a schematic view of a backrest frame after adjustment.

### DESCRIPTION OF THE PREFERRED EMBODIMENT

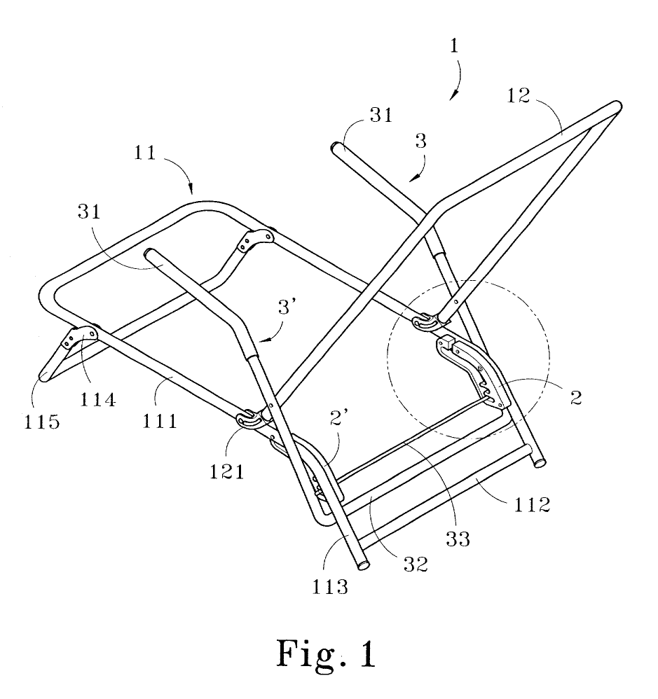

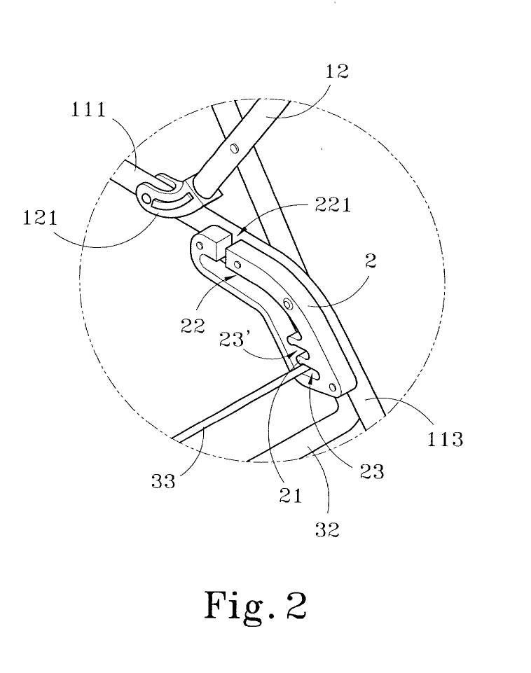

Referring to FIGS. 1 and 2, the chair 1 of the invention includes a support frame 11 which has one end pivotally engaged with a backrest frame 12. The support frame 11 has a seat pad zone 111 with two side bars bending and extending rearwards to form two rear legs 113 resting on the ground surface. The two rear legs 113 are bridged by a stretcher rod 112. The front end of the seat pad zone 111 is pivotally engaged with a front leg 115 through a front pivotal joint 114. The chair 1 thus may securely and steadily rest on the ground surface by means of the front leg 115 and rear legs 113. The backrest frame 12 is engaged with the support frame 11 by means of a rear pivotal joint 121 straddled over the support frame 11. There are two adjusting seats 2 and 2′ mounted to two sides of the support frame 11 adjacent to the backrest frame 12. Each adjusting seat 2, 2′ has a displacement slot 22 and a plurality of separating sections 21, and a slot opening 221. An adjustment notch 23 is formed between every two neighboring separating sections 21 to match the inclined angle of the backrest frame 12. On two sides of the backrest frame 12, there are also a pair of adjusting bars 3 and 3′. The adjusting bars 3 and 3′ are bridged by a displacement rod 33. The displacement rod 33 may be slipped into the displacement slot 22 through the slot opening 221. The lower ends of the adjusting bars 3 and 3′ are bridged by a reinforced bar 32 pressing against the support frame 11. The adjusting bars 3 and 3′ may be moved to actuate the displacement rod 33 moving a selected displacement in the displacement slot 22 and wedging into the adjustment notch 23. Thereby the inclined angle of the backrest frame 12 may be changed by moving the adjusting bars 3 and 3′ to adjust the matching and engaging adjustment notch 23.

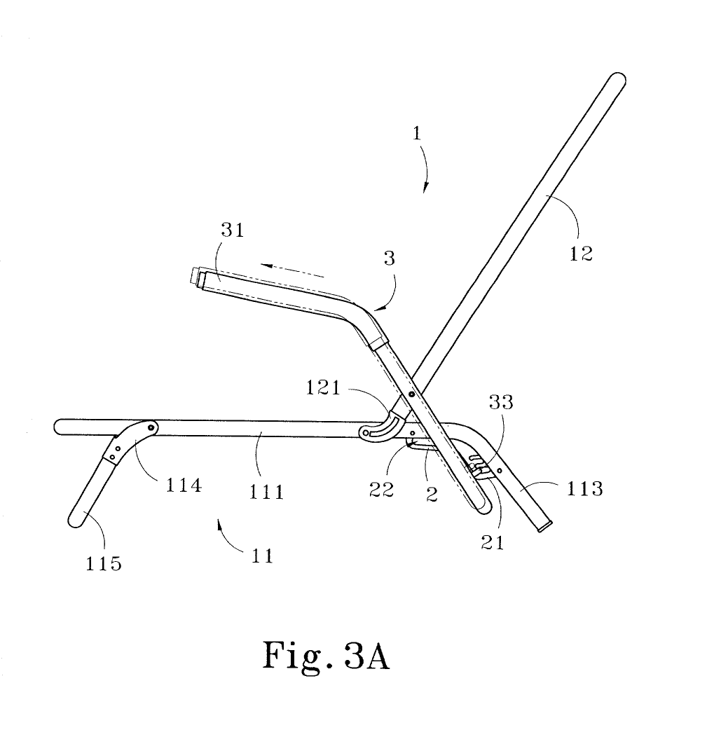

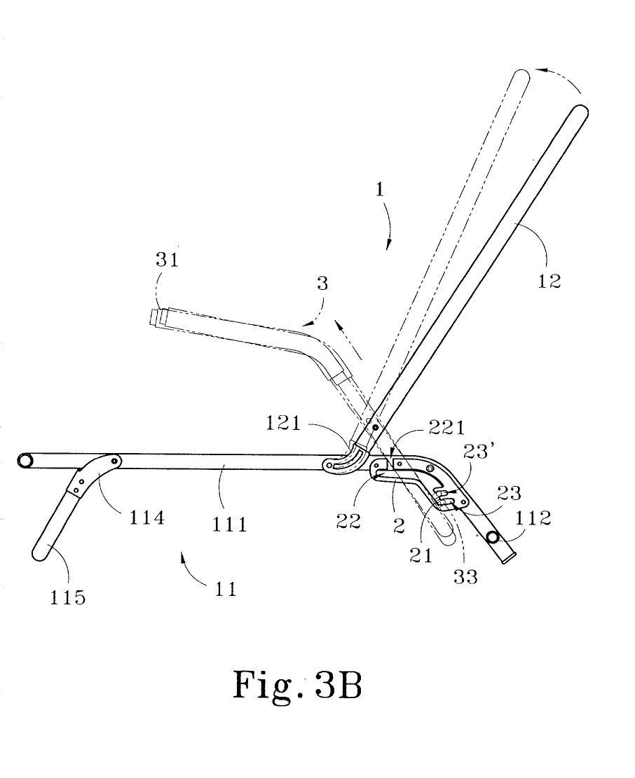

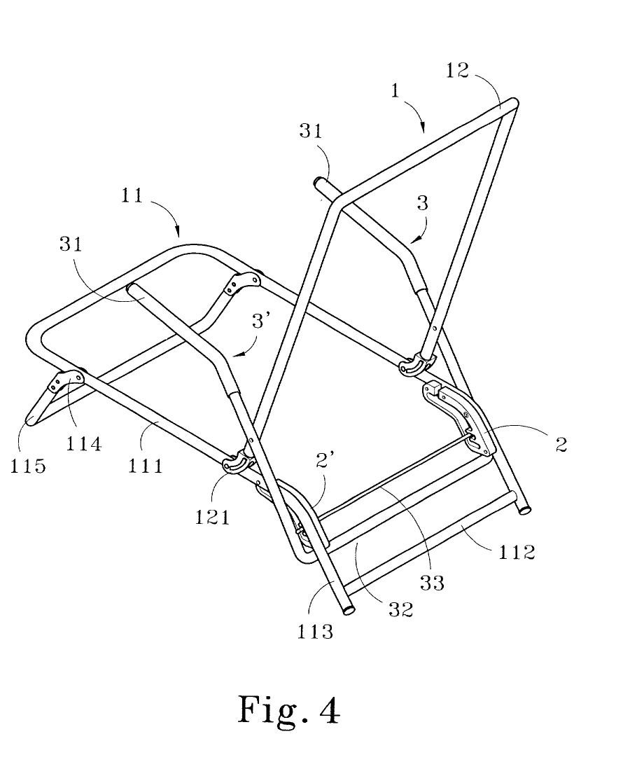

Referring to FIGS. 3A and 3B, when an user sitting on the chair 1 wants to adjust the inclined angle of the backrest frame 12, the user may move the armrests 31 located on the adjusting bars 3 and 3′ forwards to make the displacement rod 33 moving away from the adjustment notch 23 and entering into the displacement slot 22, the backrest frame 12 will be dragged forwards in the mean time by the adjusting bars 3 and 3′ and turn about the rear pivotal joint 121 pivotally engaged with the support frame 11. Then lift the armrests 31 slightly upwards to move the displacement rod 33 upwards in the displacement slot 22. When the backrest frame 12 is moved to a desired inclined angle, move the adjusting bars 3 and 3′ downwards and rearwards to wedge the displacement rod 33 into a matching adjusting notch 23′, the backrest frame 12 will be changed and positioned to a selected angle as shown in FIG. 4 (which is changed to a smaller angle from a former larger inclined angle). Users may repeat the actions set forth above to select another adjusting notch 23 until reaching desired sitting position.

What is claimed is:

1. A structure for adjusting backrest frame inclined angle of a chair, comprising:
a support frame having one end pivotally engaged with a backrest frame to form the chair and two adjusting seats mounted to two sides of the support frame adjacent to the backrest frame, each adjusting seat having a displacement slot and a plurality of separating sections with an adjustment notch formed between every two neighboring separating sections to match the inclined angle of the backrest frame; and
two adjusting bars fastened to two sides of the backrest frame having a displacement rod bridged therebetween;
wherein the adjusting bars are movable to actuate the displacement rod moving a selected displacement in the displacement slot and wedging into a selected adjustment notch to adjust the inclined angle of the backrest frame to give an user sitting on the chair most comfort.

2. The structure for adjusting backrest frame inclined angle of a chair of claim 1, wherein each adjusting seat has a slot opening formed thereon to receive the displacement rod into the adjusting seat.

3. The structure for adjusting backrest frame inclined angle of a chair of claim 1, wherein the support frame has a seat pad zone which has two side bars bending and extending rearwards to form two rear legs resting on the ground surface, the seat pad zone having a front end pivotally engaged with a front leg through a front pivotal joint.

4. The structure for adjusting backrest frame inclined angle of a chair of claim 1, wherein the support frame and the backrest frame are fastened to a rear pivotal joint straddling on the support frame.

5. The structure for adjusting backrest frame inclined angle of a chair of claim 1, wherein the two adjusting bars are bridged by a reinforced bar pressing against the support frame.

6. The structure for adjusting backrest frame inclined angle of a chair of claim 1, wherein the two adjusting bars have the front ends bent to form respectively an armrest of the chair.
